(19) United States
(12) Patent Application Publication
(10) Pub. No.: US 2006/0067525 A1
(43) Pub. Date: Mar. 30, 2006

(54) Unique product identification

(76) Inventor: Heribert Hartlage, Munchen (DE)

Correspondence Address: SIEMENS CORPORATION;INTELLECTUAL PROPERTY DEPARTMENT, 170 WOOD AVENUE, SOUTH, ISELIN, NJ, 08830, US

(21) Appl. No.: 11/239,411

(22) Filed: Sep. 29, 2005

(30) Foreign Application Priority Data
Sep. 30, 2004 (EP) EP04023347

(51) Int. Cl. H04L 9/28

(52) U.S. Cl. 380/28

(57) ABSTRACT

The components of a product are identified with the aid of checksums. The checksums are in turn identified with the aid of a master checksum. Asymmetrically encrypted digital signatures are preferably used as checksums. As a result of the capability to verify the checksums it is ensured that none of the components is modified by simultaneous replacement of a component and the associated checksum.

### CROSS REFERENCE TO RELATED APPLICATIONS

This application claims priority to the European application No. 04023347.0, filed Sep. 30, 2004 and which is incorporated by reference herein in its entirety.

### FIELD OF INVENTION

The invention relates to a product and methods regarding unique product identification.

### SUMMARY OF THE INVENTION

The international standard M.3010 (02/2000) of the ITU-T describes a reference architecture of a Telecommunications Management Network (TMN) for monitoring and controlling a network for telecommunications applications wherein it is taken as a premise that the network controlled by the TMN comprises different types of network elements that are typically controlled with the aid of different communication mechanisms (i.e. protocols, messages, management information—also called object model).

Said TMN comprises the following functionalities:
Operations Systems Function (OSF), which implements the “actual” management of the telecommunications network.
Workstation Function (WSF), which serves to represent the control operations and the network status for a human user of the TMN.
Network Element Function (NEF), which represents an interface for controlling the telecommunications functions of the network elements. The interface defines the specific communication mechanism of the respective network element, which may not be standardized. The sum of all the management information of the NE is referred to as the Management Information Base (MIB) of the NE. In the following description it is also referred to as the NE-MIB.
Transformation Function (TF), which is used to connect components having different communication mechanisms and in particular to link network elements which have no standardized NEF to the TMN. It is also referred to in the M.3010 (05/96) standard as the mediation function or as the Q adaption function.

Furthermore, the functionalities are classified as far as possible into the following groups in accordance with the FCAPS scheme:
F=Fault
C=Configuration
A=Accounting
P=Performance
S=Security

The functions are effected by material products which may be embodied, for example, as a network element (NE), operations system (OS), application, terminal, router, switch, database server or computer program product (also referred to as program, applications or software), but are not, of course, restricted thereto.

The NEF function is usually assigned to an NE, whereas the OSF and WSF functions are mostly assigned to an OS. Typically, an OS is assigned a plurality of NEs, the OS usually being centralized, whereas the NEs are distributed in the network on a non-centralized basis over a plurality of locations.

An OS can comprise a number of programs. The programs can be embodied for example as management applications for controlling different network technologies of a communication network, of which an application-specific subset of the resources of the network that is relevant to the technology controlled in each case is modeled, visualized and controlled in each case.

The programs are executed by hardware (e.g. processor, I/O module) which is provided in the material products. Said execution is supported by support software (e.g. multitasking or multithreading operating system, database system, Windows system).

The security functionality is implemented in the products for example by means of security mechanisms in which secure access to the products is made possible by means of access authorizations, e.g. by way of a user identification (userid) and a password and/or through presentation of a security certificate.

The security functionality also includes the task of allowing an unequivocal identification of an installed software application at any time. With TMN software in particular this task is especially complex, because the number of installed files and necessary configurations is very extensive due to the high number of TMN functions.

From what has been stated heretofore it is clear that the implementation of the described architecture in real solutions constitutes a highly complex technical problem as a result of the pronounced distributed nature of the system and the multiplicity of different system components and requirements.

The object of the invention is to recognize at least one of the existing problems and to solve same through specification of at least one teaching for technical action.

The invention is based on the following insights:
An unequivocal identification of the installed software is particularly important when a computer program product leaves the sphere of influence of a software vendor (manufacturer) and enters the sphere of influence of a third party by, for example, being installed on a computer of a customer of the software manufacturer—e.g. as part of the OS of a communication network operator. If there are problems with the software it is particularly important in this context to investigate whether the originally installed software has been modified and therefore whether the current software is no longer identical with the originally installed software.
Clarifying this question is frequently attended by complex issues of liability which may be of great economic importance. On account of contracts and legal provisions the provider of software is under an obligation to provide maintenance and warranty services to the customer. As these services lead to further costs for the provider (manufacturer), it is expedient to limit this work only to the files that are verified as having been supplied. Reliable product identification of the files is a prerequisite for this.
Software for managing and controlling telecommunications equipment is typically developed as a large set of individual files and installed on the target system. This results in a high level of complexity when it comes to running a check in relation to a) product identity, b) the modification of individual files, irrespective of whether this is intentional or unintentional, and c) legal or illegal use by the user.

The known techniques do not solve the problems identified or at the least have undesirable side effects:
A technique with reference to point a) provides for the product identification to be checked by means of corresponding digital logos and programmed-in data. The programmed-in data includes the company name, a product identifier and a version identifier. However, the information can be copied into modified files, so an undesired change cannot be effectively prevented.
An alternative technique is to use simple checksum methods. However, these do not satisfy the requirement for product identity to a sufficient extent. On the one hand the checksum method may be known; on the other hand checksum methods are relatively simple and the method used can be determined subsequently. It is then an easy matter to calculate the checksum oneself and so falsely simulate the product identity. As a result the product identity cannot be adequately verified in this way.
A technique with reference to point b) provides for a desired change to individual files to be carried out by the manufacturer in the context of upgrade procedures and software patches. During the process the available versions of the software are usually taken into account. In some cases new software is supplied as a complete package. The complete package is secured by means of a simple error sum or a digital signature. In this way the shipment is uniquely identified. However, after installation of the software individual files can again be modified without it being possible to verify unequivocally which of the supplied files has been changed. Only a modification of the shipment as a whole can be detected. A detailed analysis is not possible.
Undesired changes to the software, due, for example, to malicious programs such as e.g. viruses, trojans, etc. are not detected at all.
With reference to point c), licensing methods are known which, for example, place an executable wrapping around the program requiring protection. Without said wrapping the program cannot be executed. However, provided said wrapping is retained, the actual program can still be modified.

A solution to this problem situation recognized according to the invention as well as advantageous embodiments of said solution are specified in the patent claims.

The invention is explained below with reference to exemplary embodiments which are also depicted in the figures. It should be emphasized that the illustrated embodiments of the invention, in spite of their sometimes very faithfully detailed representation, are merely exemplary in nature and are not to be taken as limiting the scope of the invention.

### BRIEF DESCRIPTION OF THE DRAWING

FIG. 1 shows an exemplary product E according to the invention, comprising a plurality of components K and checksums P as well as at least one master checksum MP.

### DETAILED DESCRIPTION OF THE INVENTION

The components K are embodied for example as software S which is stored, for example, in a number of files. To simplify the illustration of the invention it is assumed that each component uniquely corresponds to a specific file. It is, however, clear to the person skilled in the art that this restriction is not mandatory and at any time a component can also comprise a plurality of files. In total m components K₁-Kₘ are shown.

The checksums P are embodied for example as hash values H. The hash values H are formed for example according to the MD5 method, wherein a corresponding character string is formed for each file taken into account. The checksums P can also be embodied as what are referred to in technical circles as digital signatures DS, which represent the result of a preferably asymmetrical encryption of the hash values H with the aid of a private key of the software manufacturer.

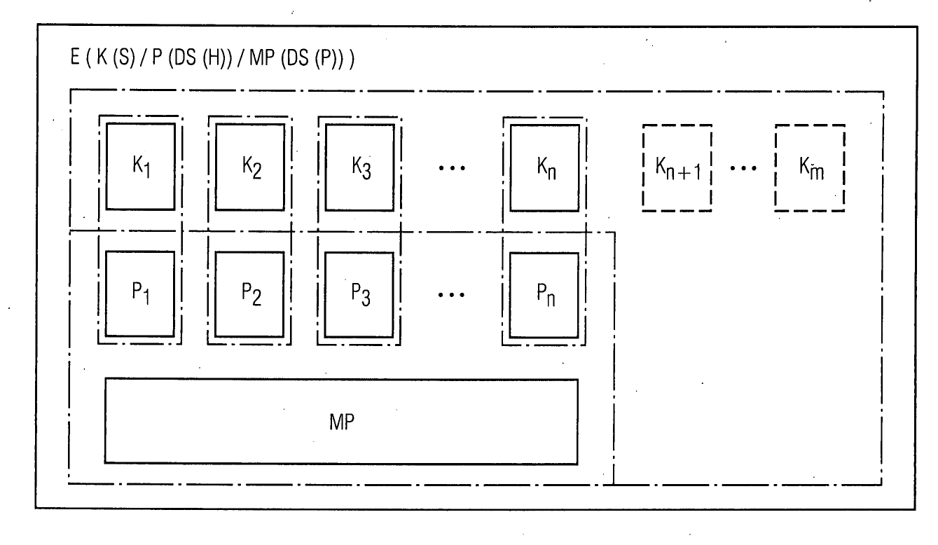

In a preferred embodiment the checksums P are formed only for such components K as remain unchanged during the life of the product E and in particular during the operation of the software S. Thus, excluded components are, for example, files K in which the passwords of users of the software S are stored, because the content of said file K changes each time the passwords are changed. Following a change the unique identity of the file K can no longer be ensured with the aid of an assigned checksum P, which in a case of such kind is also in no way desired. This situation is indicated in FIG. 1, where only n components K₁-Kₙ of the m components K₁-Kₘ (n≦m) are combined with a checksum. If all the components remain unchanged, then n=m. In this case the set of components Kₙ₊₁ to Kₘ is empty.

The at least one master checksum MP is formed at least via the checksums P, but may also be formed via an arbitrary number of components K. This freedom of choice is indicated in FIG. 1 by the fact that the dashed box in which the master checksum MP lies comprises only the checksums P in a first embodiment and in a second embodiment additionally includes the components K.

As a solution for the desired unique identification of a product E it is proposed to determine the unique identification of the product E—or, to put it in other words, the unique identity of the installed product E with the originally shipped product E—with the aid of a two-stage check mechanism. The first stage comprises checksums P by means of which individual components K of the product E can be unequivocally identified so that it is established that the components K of the originally shipped product E have not been modified. The second stage at least comprises a master checksum MP by means of which at least the checksums P are unequivocally identified so that it is ensured that the checksums P have not been changed. By means of the second stage it is thus prevented that a pair, consisting of a component K and an associated checksum P, is replaced as a whole.

A product E of said kind is produced for example in that with the production of the customer software, in each case checksums P, which are embodied for example as digital signatures DS, preferably based on asymmetrical encryption, are obtained from all files K of the software S with the exception of those that are modified during the execution of the software S. Toward that end, initially an e.g. 16-byte long character string H is formed from each file by means of hashing. Said character string H from the hashing is optionally encrypted by means of a private key and yields a digital signature DS.

The digital signatures DS are stored for example in a separate signature file. The signature file is embodied such that it is possible to establish the association between a digital signature DS and an assigned file K.

The signature file containing the digital signatures is itself in turn signed by means of a digital master signature MP. The signature file and the assigned digital master signature MP are stored for example in a common file.

The asymmetrical encryption is based on two keys, a private key and a public key. The private key is deposited with the software manufacturer responsible for producing the software. The public key is shipped together with the software S so that the digital signatures DS can be checked at the runtime of the software S.

During the checking of the unique identity of the software S, the e.g. 16-byte long character strings H are formed for the files K₁-Kₙ requiring validation by means of the same hashing mechanism as used in the production of the product E. The master signature MP is then formed from the character strings H.

The master signature MP just formed is compared with the master signature MP stored in the signature file. If the two tally, the unique identity of the checksums P is established. If either the digital master signature MP or one of the checksums P has been modified, then the character strings will no longer match one another.

Following this, the digital signatures DS are taken from the signature file and, if necessary, decrypted by means of the public key. The result of the decryption is compared with the character string H just formed. If the two character strings are a match, the files K₁-Kₙ and the digital signatures P₁-Pₙ belong together. If either a digital signature P or an associated file K has been modified, then the character strings to be determined no longer fit together. In this way the authenticity of a file K can be checked by means of a digital signature DS.

The checking of the digital signature is handled for example by an autonomous checking program which can be started both by the control software and also independently thereof. Said program then flags all files K whose digital signatures DS no longer match.

A further exemplary embodiment relates to a partial software improvement, e.g. debugging, in which individual files K are replaced at the customer site. In this case, as well as the individual files K, the corresponding digital signatures P in the signature file are also replaced and the master signature MP formed anew.

A multiplicity of further advantages is associated with the invention:
If all the unmodifiable files on the file system are digitally signed and the digital signatures are checked regularly and in addition as necessary, e.g. warranty cases, then contracts can be used to exclude warranty rights if at least one unmodifiable file possesses an invalid digital signature. Substantial cost reductions are possible in this way.
Intellectual property rights can be protected in particular also by program sections because the latter can no longer be replaced separately on account of the master signature.
Product piracy in relation to software solutions can be detected. More particularly, the manufacturers of software can be sure that their customers only acquire software from the manufacturer and do not replace parts of their supplied software with third-party products.
With the aid of the digital signatures the customer can be sure that the bug fixes and the successor versions of the software come from the manufacturer.
Malicious programs such as, for example, a virus can modify individual files. As a result the proper operation of the software can be adversely affected or even inhibited altogether. With the aid of the digital signatures the checking software can establish whether files have been changed. It is possible at any given time to check the individual unmodifiable files of the software to determine whether said files have been modified, for example by malicious programs.
Changes to files can be detected promptly and indicated to the user of the software on the basis of the checking program. Other responses such as stopping the software are also conceivable. In this way, in the case of changes by malicious programs in particular, further damage can be averted also from the network elements to be managed. Through rapid detection of invalid changes, damage to the system is reduced to a minimum. As a result of the reduction in OPEX (OPerational EXpenses) effected in this way, economic advantages are produced for a network operator.
If parts of the software are to be sold independently, then said parts should be licensable separately, particularly when all portions of the software are supplied in spite of an only partial licensing. Shipping the complete software simplifies the software provisioning logistics considerably for the manufacturer. In particular the amount of software configurations to be supplied can be substantially reduced.
The program that checks the digital signatures can also decide on the basis of license keys whether files to be called are being used legally or not. Toward that end, (unmodifiable) features from the files of the control software are compared with features from the associated license key. On the basis of the digital signature a use of separately licensable software for example is effected in that files which belong to the separately licensable software are provided with a license mark that is part of the file and consequently is also protected by the digital signature. The use of said files is only possible if a corresponding license key is read into the system and is subsequently successfully verified with the license mark and the digital signature of said files. The license mark is loaded, for example, as a further unmodifiable file together with a correspondingly extended license mark of the signature file at the customer site and subsequently processed according to the invention by the checking program. In particular Java-based applications that are only developed and marketed at a later time can be more easily integrated in this way into an already existing software system and licensing method.
The specific application of digital signatures to the unmodifiable files in the product permits product identification, product security and a novel type of licensing. For example, executable files are stored as unmodifiable in the file system. It is immaterial in this case if said files, when uploaded into the main memory, are modified during the program execution in the main memory. Only if the changes made in the main memory are written back into the file stored in the file system, is such a file no longer unmodifiable. The following other files stored in the file system can be regarded as unmodifiable in this sense: dynamically linkable library files, graphics files, . . .
An implementation of the invention requires no fundamental changes to the existing prior art, but essentially can be inserted retroactively as a module—in particular as a modified or additional computer program product.
The time of implementation is independent of the time of implementation of other functions.
It is ensured by means of the invention that the individual components of the overall system are subjected to load only to a minor extent, thereby increasing the stability of the system as a whole.

In conclusion it should be pointed out that the description of the components of the system that are relevant to the invention is categorically not to be understood as limiting with regard to a specific physical implementation or assignment. It is particularly obvious to a person skilled in the relevant art that the invention can be implemented partially or in its entirety in software and distributed over a plurality of physical products/computer program products.

1.-10. (canceled)

11. A product, comprising:
components;
check values for checking the integrity of at least a part of the components; and
at least one master check value for checking the integrity of at least the check values.

12. The product as claimed in claim 11, wherein the components are embodied as software.

13. The product as claimed in claim 11, wherein each component is assigned a check value and vice versa.

14. The product as claimed in claim 12, wherein each component is assigned a check value and vice versa.

15. The product as claimed in claim 11, wherein at least the master check value is embodied as a digital signature.

16. The product as claimed in claim 12, wherein at least the master check value is embodied as a digital signature.

17. The product as claimed in claim 13, wherein at least the master check value is embodied as a digital signature.

18. The product as claimed in claim 14, wherein at least the master check value is embodied as a digital signature.

19. A method for producing a product according to claim 11, the method comprising the following steps:
generating the check values taking the components into account;
generating at least one master check value taking the check values into account; and
producing the product by combining the components, the digital signatures, and the master signature.

20. The method as claimed in claim 19, wherein a check value embodied as a digital signature is generated with the aid of an asymmetrical encryption method.

21. The method as claimed in claim 19, wherein the check values are formed from hash values which are generated taking the components into account.

22. The method as claimed in claim 21, wherein the hash values are MD5 hash values.

23. The method as claimed in claim 20, wherein the check values are formed from hash values which are generated taking the components into account.

24. The method as claimed in claim 19, wherein, if a modification is made to a component at least the checksum assigned to said component as well as the master checksum are regenerated, and wherein the whole is subsequently combined to form a modified product.

25. The method as claimed in claim 20, wherein, if a modification is made to a component at least the checksum assigned to said component as well as the master checksum are regenerated, and wherein the whole is subsequently combined to form a modified product.

26. The method as claimed in claim 21, wherein, if a modification is made to a component at least the checksum assigned to said component as well as the master checksum are regenerated, and wherein the whole is subsequently combined to form a modified product.

27. The method as claimed in claim 19, wherein check values are generated only for those components that remain unchanged during the life of the product.

28. The method as claimed in claim 20, wherein check values are generated only for those components that remain unchanged during the life of the product.

29. A checking method for the unequivocal identification of a product according to claim 11, the method comprising the following steps:
regenerating the check values taking the components of the product into account;
checking, while taking the master check value into account, whether the check values encompassed by the product are unchanged;
comparing the check values checked in this way with the regenerated check values; and
confirming an unique identification if all the compared check values match.
